(19) United States
(12) Patent Application Publication
(10) Pub. No.: US 2023/0347296 A1
(43) Pub. Date: Nov. 2, 2023

(54) ARTICLE INCLUDING FILTRATION MEDIA AND FLUOROPOLYMER AND METHODS OF MAKING AND USING SAME

(71) Applicant: Donaldson Company, Inc., Bloomington, MN (US)

(72) Inventors: Stephen K. Sontag, Plymouth, MN (US); Matthew P. Goertz, Bloomington, MN (US)

(21) Appl. No.: 18/022,013

(22) PCT Filed: Aug. 17, 2021
(86) PCT No.: PCT/US2021/046256

§ 371 Date: Feb. 17, 2023

Related U.S. Application Data
(60) Provisional application No. 63/067,053, filed on Aug. 18, 2020.

(51) Int. Cl. B01D 69/02; B01D 67/00; B01D 71/36

(52) U.S. Cl. CPC B01D 69/02; B01D 67/0088; B01D 71/36; B01D 67/0095; B01D 2323/04; B01D 2325/38; B01D 2323/219; B01D 2323/081

(57) ABSTRACT

Articles including poly(2,2,3,3,4,4,4-heptafluorobutyl methacrylate) or poly(2,2,3,3,4,4,4-heptafluorobutyl acrylate), fluoropolymers that do not form perfluorooctanoic acid (PFOA) when they degrade and that exhibit unexpectedly good oil repellency, are described. A method of making a fluoropolymer-containing article includes depositing a fluoropolymer-liquid mixture onto porous filtration medium by contacting the porous filtration medium with a mixture comprising a fluoropolymer and a liquid to form the treated porous filtration medium; and removing the liquid. The fluoropolymer includes poly(2,2,3,3,4,4,4-heptafluorobutyl methacrylate) or poly(2,2,3,3,4,4,4-heptafluorobutyl acrylate). Methods of using the article are further described.

### RELATED APPLICATIONS

This application claims priority to U.S. Provisional Application No. 63/067,053, filed on Aug. 18, 2020, incorporated by reference herein.

### BACKGROUND

Fluorinated chemicals have allowed for the creation of surfaces that repel not only water, but also oils. However, fluoropolymers with long fluoroalkyl side chains have been confirmed to produce perfluoroalkyl acids by hydrolyzation and oxidative degradation. For polymers with perfluorooctyl side groups, degradation may result in the production of perfluorooctanoic acid (PFOA), which can persistent and bioaccumulate in the environment.

### SUMMARY

This disclosure describes articles including poly(2,2,3,3,4,4,4-heptafluorobutyl methacrylate) or poly(2,2,3,3,4,4,4-heptafluorobutyl acrylate), fluoropolymers that do not form perfluorooctanoic acid (PFOA) when they degrade and that exhibit unexpectedly good oil repellency. The articles include a porous filtration membrane to which the fluoropolymer has been applied (for example, coated). This disclosure further describes methods of making the fluoropolymer-containing articles and methods of using the fluoropolymer-containing articles.

In one aspect, this disclosure describes an article that includes a porous filtration medium and a fluoropolymer, wherein the fluoropolymer is disposed on the porous filtration medium, forming a treated porous filtration medium. The treated porous filtration medium is oleophobic on at least one major surface .The treated porous filtration medium has an oleophobicity of 1 or higher, 2 or higher, 3 or higher, 4 or higher, 5 or higher, or 6 or higher on at least one major surface, as determined by AATCC test method 118. The oleophobicity may be up to 8 or up to 7. The fluoropolymer includes poly(2,2,3,3,4,4,4-heptafluorobutyl methacrylate) or poly(2,2,3,3,4,4,4-heptafluorobutyl acrylate).

In another aspect, this disclosure describes a method of making an article that includes a treated porous filtration medium. The method includes depositing a fluoropolymer-liquid mixture onto a porous filtration medium by contacting the porous filtration medium with the mixture comprising a fluoropolymer and a liquid, to form the treated porous filtration medium, and removing the liquid. The fluoropolymer includes poly(2,2,3,3,4,4,4-heptafluorobutyl methacrylate) or poly(2,2,3,3,4,4,4-heptafluorobutyl acrylate).

As used herein, “oleophobicity” refers to a rating on a scale of 1 to 8, determined according to AATCC TM118-2013e2 entitled “Oil Repellency: Hydrocarbon Resistance Test” modified by rounding the oleophobicity ratings to the nearest integer value.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements.

By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements.

Thus, the phrase “consisting essentially of” indicates that the listed elements are required or mandatory, but that other elements are optional and may or may not be present depending upon whether or not they materially affect the activity or action of the listed elements.

Unless otherwise specified, “a,” “an,” “the,” and “at least one” are used interchangeably and mean one or more than one.

As used herein, the term “or” is generally employed in its usual sense including “and/or” unless the content clearly dictates otherwise.

The term “and/or” means one or all of the listed elements or a combination of any two or more of the listed elements.

Any reference to standard methods (e.g., ASTM, TAPPI, AATCC, etc.) refer to the most recent available version of the method at the time of filing of this disclosure unless otherwise indicated.

Also herein, the recitations of numerical ranges by endpoints include all numbers subsumed within that range (e.g., 1 to 5 includes 1, 1.5, 2, 2.75, 3, 3.80, 4, 5, etc.).

Herein, “up to” a number (for example, up to 50) includes the number (for example, 50).

The term “in the range” or “within a range” (and similar statements) includes the endpoints of the stated range.

For any method disclosed herein that includes discrete steps, the steps may be conducted in any feasible order. And, as appropriate, any combination of two or more steps may be conducted simultaneously.

All headings are for the convenience of the reader and should not be used to limit the meaning of the text that follows the heading, unless so specified.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

In the context of polymers, the phrase “high molecular weight” is used to refer to polymers having a weight average molecular weight (Mn) of at least 10 kDa. The phrase “low molecular weight” is used to refer to polymers having a weight average molecular weight (Mn) of less than 10 kDa.

Unless otherwise indicated, all numbers expressing quantities of components, molecular weights, and so forth used in the specification and claims are to be understood as being modified in all instances by the term “about.” As used herein in connection with a measured quantity, the term “about” refers to that variation in the measured quantity as would be expected by the skilled artisan making the measurement and exercising a level of care commensurate with the objective of the measurement and the precision of the measuring equipment used. Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGS.

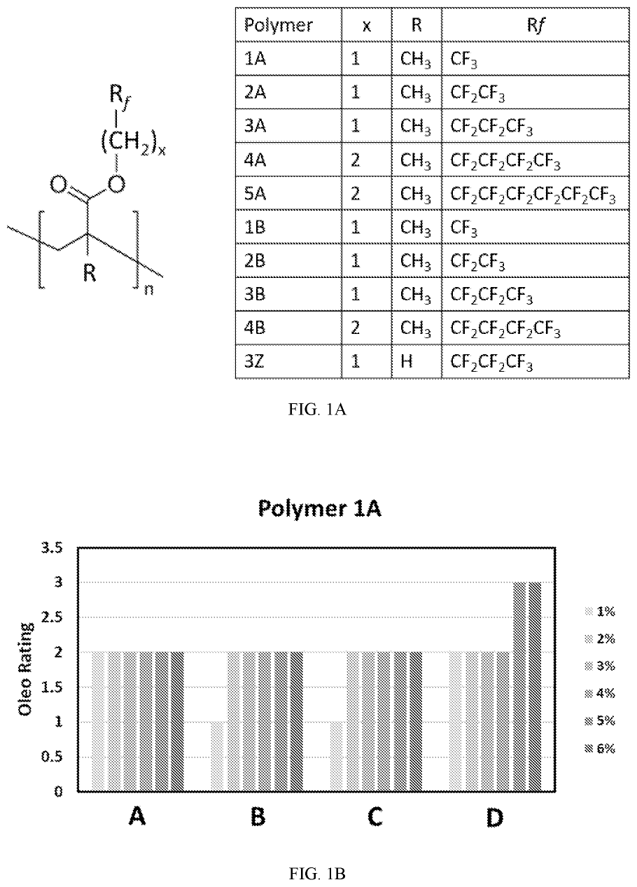

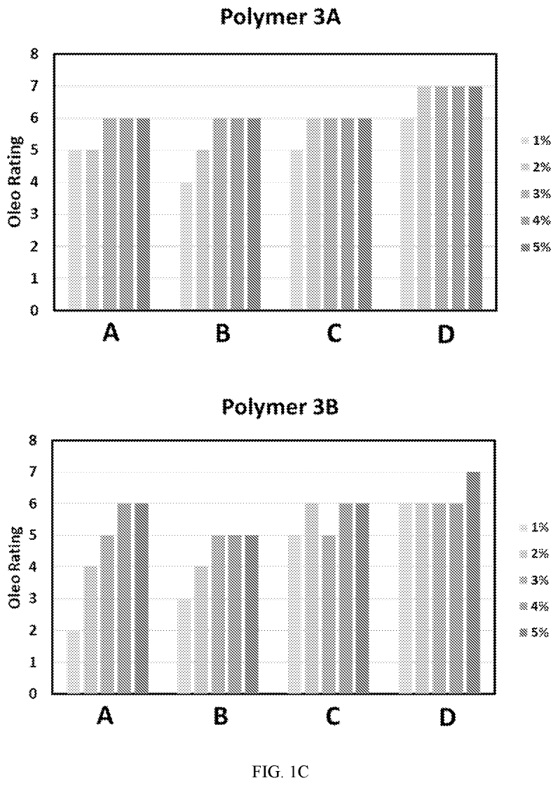

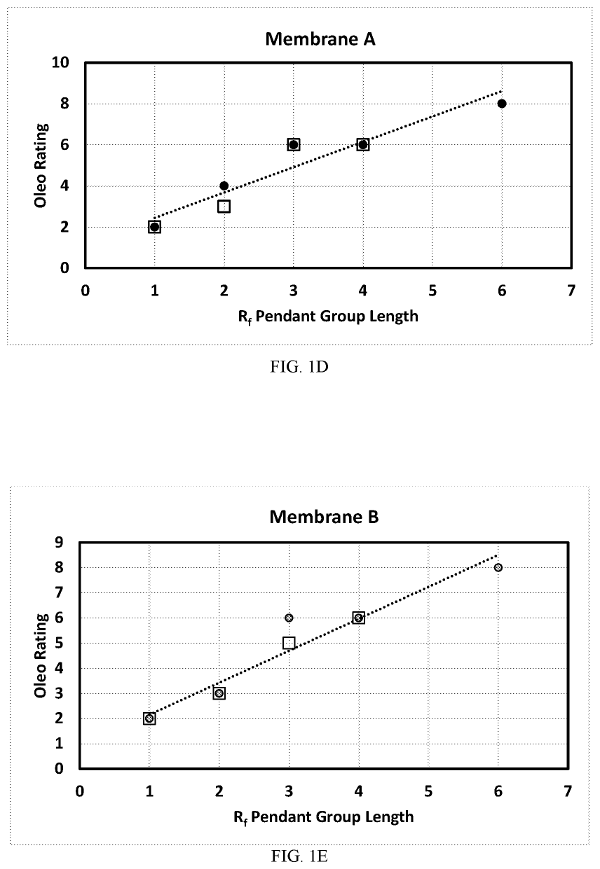

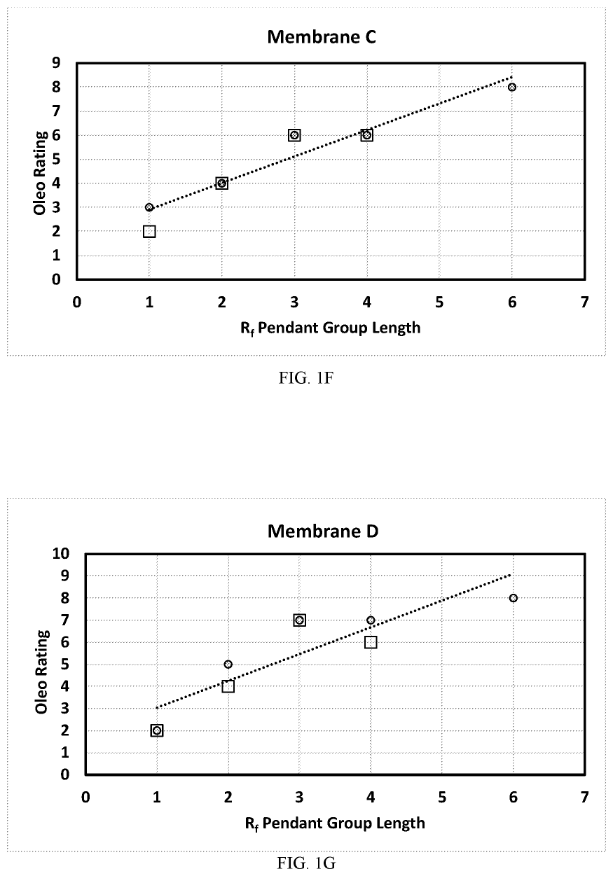

FIG. 1A shows the structures of polymers used in the Examples of this disclosure, demonstrating the different chain lengths of the fluorinated segment.

FIG. 1B shows the oleophobicity ratings of different concentrations of high Mn poly(2,2,2-trifluoroethyl methacrylate) (“Polymer 1A”) polymer solution on four different types of media, as further described in Example 1.

FIG. 1C shows the oleophobicity rating of different concentrations of poly(2,2,3,3,4,4,4-heptafluorobutyl methacrylate) solution on four different types of media, as further described in Example 1. Top panel shown Polymer 3A and bottom panel show Polymer 3B.

FIG. 1D-FIG. 1G each show a plot of the number of fluorinated carbons in the pendant group of different polymers versus the oleophobicity rating of the polymer on four different media types (Membrane A-Membrane D, respectively), as further described in Example 1. High Mn polymer (Polymers 1A, 2A, 3A, 4A, and 5A) data points are represented by filled circles; low Mn polymer (Polymers 1B, 2B, 3B, and 4B) data points are represented by open squares. Dotted lines are trendline (best linear fit), calculated with Microsoft Excel using all of the values plotted.

### DETAILED DESCRIPTION

This disclosure describes articles including poly(2,2,3,3,4,4,4-heptafluorobutyl methacrylate) or poly(2,2,3,3,4,4,4-heptafluorobutyl acrylate), fluoropolymers that do not form perfluorooctanoic acid (PFOA) when they degrade and that exhibit unexpectedly good oil repellency. The articles include a porous filtration membrane on which the fluoropolymer is disposed. This disclosure further describes methods of making the fluoropolymer-containing articles and methods of using the fluoropolymer-containing articles.

### Fluoropolymers

Poly(2,2,3,3,4,4,4-heptafluorobutyl methacrylate) (also referred to herein as Polymer 3A or Polymer 3B) may be depicted as shown in Formula I:

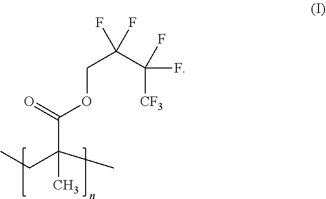

Poly(2,2,3,3,4,4,4-heptafluorobutyl acrylate) (also referred to herein as Polymer 3Z) may be depicted as shown in Formula II:

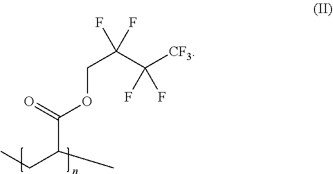

For Formula I or Formula II, n is typically at least 10, at least 25, at least 50, at least 70, more preferably at least 200, or most preferably at least 400. In some embodiments for Formula I or Formula II, n may be up to 500, up to 600, up to 1000, or up to 1100. For example, in an exemplary embodiment, n may be in a range of 70 to 1000. N may be in a range of 100 to 800. In another exemplary embodiment, n is in a range of 150 to 500.

Without wishing to be bound by theory, it is believed that although higher molecular weight polymers (that is, polymers having a high n of, for example, at least 1,000) may not provide improved initial oleophobicity over lower molecular weight polymers (for example, polymers having an of less than 80), porous filtration media having higher molecular weight polymers disposed thereon may show increased resistance to a drop in oleophobicity when exposed to certain liquids (such as gasoline) than porous filtration media having lower molecular weight polymers disposed thereon, and thus higher molecular weight polymers may provide improved oleophobicity during use of the articles.

Thus, in some embodiments, when the fluoropolymer comprises poly(2,2,3,3,4,4,4-heptafluorobutyl methacrylate), the number average molecular weight (Mn) of the fluoropolymer is at least 3 kDa, at least 5 kDa, at least 10 kDa, at least 100 kDa, at least 150 kDa, at least 200 kDa, at least 250 kDa, at least 300 kDa, or at least 350 kDa. In some embodiments, when the fluoropolymer comprises poly(2,2,3,3,4,4,4-heptafluorobutyl acrylate), the number average molecular weight (Mn) of the fluoropolymer is at least 10 kDa, at least 100 kDa, at least 150 kDa, at least 200 kDa, at least 250 kDa, at least 300 kDa, or at least 350 kDa.

Poly(2,2,3,3,4,4,4-heptafluorobutyl methacrylate) or poly(2,2,3,3,4,4,4-heptafluorobutyl acrylate) may be commercially obtained (including, for example, from Polymer Source, Montreal, Canada; or Sigma Aldrich, St. Louis Missouri) or may be synthesized using know polymerization techniques. Exemplary polymerization techniques for both polymers are described in the Examples.

### Porous Filtration Medium

Any suitable porous filtration medium may be used as a part of the fluoropolymer-containing article or to form the fluoropolymer-containing article.

In some embodiments, the porous filtration medium may include expanded polytetrafluoroethylene (ePTFE), cellulose, cellulose acetate, polyurethane, polypropylene, polyethylene, polyether sulfone, polyvinylidene fluoride, polycarbonate, polyolefin, polyamide (nylon), polyester, polysulfone, polyether, acrylic polymers, methacrylic polymers, polystyrene, cellulosic polymer, or glass, or a combination thereof (for example, blends, mixtures, or copolymers thereof).

In some embodiments, the porous filtration medium may preferably include expanded polytetrafluoroethylene (ePTFE).

In some embodiments, the porous filtration medium may include a membrane, a nonwoven web, a woven web, a porous sheet, a sintered plastic, a sintered metal, a screen (including for example, a woven screen, an expanded screen, an extruded screen, etc.), or a high density mesh, or combinations thereof.

In some embodiments, the porous filtration medium may include synthetic fibers, naturally occurring fibers, or combinations thereof (for example, blends or mixtures thereof). The substrate is typically of a porous nature and of a specified and definable performance characteristic such as pore size, Frazier air permeability, and/or another suitable metric.

In some embodiments, the porous filtration medium may include a thermoplastic or a thermosetting polymer fiber. The polymers of the fiber may be present in a single polymeric material system, in a bicomponent fiber, or in a combination thereof. A bicomponent fiber may include, for example, a thermoplastic polymer. In some embodiments, a bicomponent fiber may have a core-sheath structure, including a concentric or a non-concentric structure. In some embodiments, the sheath of the bicomponent fiber may have a melting temperature lower than the melting temperature of the core such that, when heated, the sheath binds to the other fibers in the layer while the core maintains structural integrity. Additional exemplary embodiments of bicomponent fibers include side-by-side fibers or island-in-the-sea fibers.

In some embodiments, the porous filtration medium may include a cellulosic fiber including, for example, a softwood fiber (such as mercerized southern pine), a hardwood fiber (such as Eucalyptus fibers), a regenerated cellulose fiber, a mechanical pulp fiber, or a combination thereof (for example, a mixture or blend thereof).

In some embodiments, the porous filtration medium may include a glass fiber including, for example, a microglass, a chopped glass fiber, or a combination thereof (for example, a mixture or blend thereof).

### Methods of Making the Fluoropolymer-Containing Articles

Fluoropolymer (poly(2,2,3,3,4,4,4-heptafluorobutyl methacrylate) or poly(2,2,3,3,4,4,4-heptafluorobutyl acrylate)) is disposed on the porous filtration medium to form a treated porous filtration medium. The treated porous filtration medium may form the fluoropolymer-containing article or a portion of the fluoropolymer-containing article.

In some embodiments, in addition to the treated porous filtration medium, the fluoropolymer-containing article may further include a support layer. The support layer may be added before or after the treatment of the porous filtration medium to form the treated porous filtration medium. Any suitable material may be used for the support layer, depending on the intended use of the article. In an exemplary embodiment, however, the support layer may include a polymer material such as polypropylene, polyethylene, polyester, or nylon, or a combination thereof (for example, a mixture or blend thereof).

In some embodiments, when a first major surface of the support layer is in contact with a first major surface of the porous filtration medium, the support layer may be added before treatment of the porous filtration medium with the fluoropolymer so that the fluoropolymer is coated on a second major surface of the porous filtration medium and a second major surface of the porous filtration medium.

In some embodiments, when the fluoropolymer is disposed on the porous filtration medium, the porous filtration medium may be formed by depositing a fluoropolymer-liquid mixture onto the porous filtration medium by contacting the porous filtration medium with a mixture including the fluoropolymer and a liquid, and removing the liquid. In some embodiments, the liquid in the fluoropolymer-liquid solution includes a solvent, that is, a liquid in which at least some of the fluoropolymer is dissolved. Alternatively, however the fluoropolymer may be applied to the porous filtration medium via an emulsion. For example, the fluoropolymer may be applied to the porous filtration medium via water-fluoropolymer emulsion.

After removal of the liquid, the fluoropolymer is disposed on at least one major surface of the porous filtration medium. For example, as described in an exemplary embodiment in the Examples, the fluoropolymer may be coated on a porous filtration medium by dipping the porous filtration medium in a mixture including the fluoropolymer and a solvent and then removing the solvent.

When the liquid includes a solvent, any suitable solvent may be used. In some embodiments, the fluoropolymer may be completely dissolved in the solvent when the fluoropolymer is applied to the porous filtration medium. Without wishing to be bound by theory, it is believed that a solution in which the fluoropolymer is completely dissolved in the solvent may be preferred when the porous filtration medium has small pore sizes (for example, less than 0.1 μm); however, a solution or an emulsion may be used when the porous filtration medium has larger pore sizes.

In some embodiments, the solvent may include an organic solvent. Alternatively, the solvent may include an inorganic solvent such as supercritical carbon dioxide (SCCO₂).

Exemplary organic solvents include methyl ethyl ketone (MEK) and a fluorosolvent including, for example, a fluorinated heptane and a fluorinated ether. Exemplary fluorinated ethers include ethoxy nonafluorobutane, ethoxy nonafluoroisobutane, methoxy nonafluorobutane (also referred to as methyl nonafluorobutyl ether), and methoxy nonafluoroisobutane (also referred to as methyl nonafluoroisobutyl ether). Combinations of fluorinated ethers may also be used. In some embodiments, the fluorinated ether may include a Novec™ Engineering Fluid (3M, St. Paul, MN) such as Novec™ 7100 (which includes methyl nonafluoroisobutyl ether and methyl nonafluorobutyl ether) or Novec™ 7200 (which includes two inseparable isomers of ethoxy-nonafluorobutane).

The amount of fluoropolymer included in the fluoropolymer-liquid mixture at the time of coating may be selected depending on the desired oleophobicity. In some embodiments, the amount of fluoropolymer in the mixture may be up to 8%, up to 7%, up to 6% (w/v), up to 5% (w/v), up to 4% (w/v), up to 3% (w/v), up to 2.5% (w/v), up to 2% (w/v), up to 1.5% (w/v), or up to 1% (w/v). In some embodiments, the amount of fluoropolymer in the mixture may be at least 0.5% (w/v), at least 1% (w/v), at least 1.5% (w/v), at least 2% (w/v), at least 2.5% (w/v), at least 3% (w/v), at least 4% (w/v), at least 5% (w/v), or at least 6%.

In some embodiments, contacting the porous filtration medium with the fluoropolymer-liquid mixture includes immersing the porous filtration medium in the fluoropolymer-liquid mixture. In an exemplary embodiment, immersing the porous filtration medium in the fluoropolymer-liquid mixture includes passing the porous filtration medium through the fluoropolymer-liquid mixture so that the media enter and exits the fluoropolymer-liquid mixture at approximately the same angle.

In some embodiments, the liquid of the fluoropolymer-liquid mixture may be removed from the porous filtration medium by drying at an ambient temperature (for example, at a temperature in a range of 20° C. to 25° C.) for a time sufficient to remove the liquid (for example, a solvent).

In some embodiments, applying fluoropolymer to the porous filtration medium to form a treated porous filtration medium may further include heat treating the treated porous filtration medium. Such heating may remove the liquid from the fluoropolymer-liquid mixture after the fluoropolymer is deposited on the porous filtration medium. Moreover, without wishing to be bound by theory, it is believed that such heat treatment or “curing” may also increase the oleophobicity of the treated porous filtration medium by facilitating orientation of the fluoropolymer.

The porous filtration medium may be heated by any suitable means. In an exemplary embodiment, the porous filtration medium is heated in an oven. In another exemplary embodiment, the porous filtration medium may be heated using a hot roller, steam, an infrared heater, etc.

In some embodiments, including when the porous filtration medium is heated in an oven, the porous filtration medium may be heated at a temperature greater than the glass transition temperature of the fluoropolymer. In some embodiments, the porous filtration medium is heated at a temperature of at least 70° C., at least 80° C., at least 90° C., at least 100° C., at least 110° C., or at least 120° C. In some embodiments, the porous filtration medium is heated at a temperature of up to 130° C., up to 140° C., or up to 150° C. For example, in an exemplary embodiment, the porous filtration medium may be heated at a temperature in a range of 110° C. to 130° C. In the Examples, the porous filtration medium is heated at a temperature of 120° C.

In some embodiments, including when the porous filtration medium is heated using a hot roller, steam, an infrared heater, the porous filtration medium may be heated to a temperature greater than the glass transition temperature of the fluoropolymer. In some embodiments, the porous filtration medium is heated at a temperature to at least 70° C., at least 80° C., at least 90° C., at least 100° C., at least 110° C., or at least 120° C. In some embodiments, the porous filtration medium is heated to a temperature of up to 130° C., up to 140° C., or up to 150° C. For example, in an exemplary embodiment, the porous filtration medium may be heated to a temperature in a range of 110° C. to 130° C.

In some embodiments, the porous filtration medium may be heated for at least 1 minute, at least 2 minutes, or at least 3 minutes. In some embodiments, the porous filtration medium may be heated for up to 3 minutes, up to 4 minutes, up to 5 minutes, or up to 10 minutes. For example, in in an exemplary embodiment, the porous filtration medium may be heated for at least 1 minute and up to 10 minutes. In the Examples, the porous filtration medium is heated for 3 minutes or 5 minutes.

### Treated Porous Filtration Medium

According to an embodiment, after fluoropolymer (poly(2,2,3,3,4,4,4-heptafluorobutyl methacrylate) or poly(2,2,3,3,4,4,4-heptafluorobutyl acrylate)) has been disposed on the porous filtration medium to form the treated porous filtration medium, the treated porous filtration medium is oleophobic on at least one major surface of the porous filtration medium, as determined by AATCC test method 118 and rounding the oleophobicity ratings to the nearest integer value. After fluoropolymer (poly(2,2,3,3,4,4,4-heptafluorobutyl methacrylate) or poly(2,2,3,3,4,4,4-heptafluorobutyl acrylate)) has been disposed on the porous filtration medium to form the treated porous filtration medium, the treated porous filtration medium exhibits an oleophobicity of 1 or higher, 2 or higher, 3 or higher, 4 or higher, 5 or higher, or 6 or higher on at least one major surface of the porous filtration medium, as determined by AATCC test method 118 and rounding the oleophobicity ratings to the nearest integer value. In some embodiments, the treated porous filtration medium exhibits an oleophobicity of up to 7 on at least one major surface of the porous filtration medium. The oleophobicity of the treated porous filtration medium may be 8 or lower. The oleophobicity of the treated porous filtration medium may be 3 or higher, 4 or higher, or 5 or higher. In an exemplary embodiment, the treated porous filtration medium exhibits an oleophobicity in a range of 5 to 7 or in a range of 6 to 7.

In some embodiments, the treated porous filtration medium exhibits the same oleophobicity rating on two major surfaces of the porous filtration medium. For example, the treated porous filtration medium may exhibit an oleophobicity in a range of 1 or higher, 2 or higher, 3 or higher, 4 or higher, 5 or higher, or 6 or higher, or from 5 to 7 or from 6 to 7, on two major surfaces of the porous filtration medium (for example, on a front side and a backside of the porous filtration medium). The oleophobicity of the treated porous filtration medium may be 8 or lower on two major surfaces of the porous filtration medium. The oleophobicity of the treated porous filtration medium may be 3 or higher, 4 or higher, or 5 or higher on two major surfaces of the porous filtration medium.

In some embodiments, two major surfaces of the fluoropolymer-containing article may exhibit an oleophobicity in a range of 1 or higher, 2 or higher, 3 or higher, 4 or higher, or 5 or higher, or from 5 to 7 or in a range of 6 to 7. The oleophobicity of the two major surfaces of the fluoropolymer-containing article may be 8 or lower. The oleophobicity of the two major surfaces of the fluoropolymer-containing article may be 3 or higher, 4 or higher, or 5 or higher. For example, when a first major surface of a support layer is in contact with a first major surface of the porous filtration medium, a second major surface of the porous filtration medium and a second major surface of the porous filtration medium may exhibit an oleophobicity in a range of 5 to 7 or in a range of 6 to 7.

That an oleophobicity of at least 5 or at least 6 can be obtained using poly(2,2,3,3,4,4,4-heptafluorobutyl methacrylate) was surprising because, as further described in Example 1, this polymer — at both high and low number average molecular weight (Mn) — exhibits increased oleophobicity compared to other fluoropolymer methacrylates. Specifically, poly(2,2,3,3,4,4,4-heptafluorobutyl methacrylate) exhibits oleophobicity like that of poly(lH,1H,2H,2H-nonafluorohexyl methacrylate); poly(lH,1H,2H,2H-nonafluorohexyl methacrylate) has an additional fluorinated carbon relative to poly(2,2,3,3,4,4,4-heptafluorobutyl methacrylate) and would, therefore, be expected to have increased oleophobicity.

Moreover, an oleophobicity of at least 5 or at least 6 can also be obtained using poly(2,2,3,3,4,4,4-heptafluorobutyl acrylate), as further described in Example 3.

### Methods of Using the Fluoropolymer-Containing Articles

The fluoropolymer-containing articles described herein may be used for any suitable application. In exemplary embodiments, the fluoropolymer-containing articles may be used as a biphasic separator. The two phases to be separated may be selected depending on the intended use of the article. For example, the articles may be used as an air/oil separator for air compressors, as a water/fuel separator, or as a water/oil separator. In some embodiments, the separator may be a coalescer.

### Exemplary Article Aspects

Aspect 1 is an article comprising: a porous filtration medium; and a fluoropolymer disposed on the porous filtration medium forming a treated porous filtration medium; wherein the treated porous filtration medium has an oleophobicity of 1 or higher, 2 or higher, 3 or higher, 4 or higher, 5 or higher or 6 or higher on at least one major surface, as determined by AATCC test method 118 and rounding the oleophobicity ratings to the nearest integer value; and wherein the fluoropolymer comprises poly(2,2,3,3,4,4,4-heptafluorobutyl methacrylate) or poly(2,2,3,3,4,4,4-heptafluorobutyl acrylate). The treated porous filtration medium may have an oleophobicity of 7 or lower or 8 or lower on at least one major surface. The treated porous filtration medium may have an oleophobicity of 3 to 8, from 4 to 8, or from 5 to 7.

Aspect 2 is the article of Aspect 1 wherein the porous filtration medium comprises expanded polytetrafluoroethylene (ePTFE), polyurethane, polypropylene, polyethylene, polyether sulfone, polyvinylidene fluoride, polycarbonate, polyolefin, polyamide, polyester, polysulfone, polyether, acrylic polymers, methacrylic polymers, polystyrene, a cellulosic polymer, or glass, or a combination thereof.

Aspect 3 is the article of Aspect 1 or 2, wherein the treated porous filtration medium is formed by a method comprising: contacting the porous filtration medium with a mixture comprising the fluoropolymer and a liquid, depositing the fluoropolymer-liquid mixture onto the porous filtration medium, and removing the liquid.

Aspect 4 is the article of Aspect 3, wherein the liquid comprises an organic solvent. Aspect 5 is the article of Aspect 4, wherein the organic solvent comprises methyl ethyl ketone (MEK) or a fluorosolvent.

Aspect 6 is the article of Aspect 5, wherein the fluorosolvent comprises a fluorinated ether.

Aspect 7 is the article of any one of Aspects 4 to 6, wherein the fluoropolymer-liquid mixture comprises a fluoropolymer completely dissolved in the organic solvent.

Aspect 8 is the article of any one of Aspects 6 to 7, wherein the fluoropolymer-liquid mixture comprises an emulsion.

Aspect 9 is the article of any one of Aspects 3 to 8, wherein forming the treated porous filtration medium further comprises heat treating the treated porous filtration medium.

Aspect 10 is the article of Aspect 9, wherein heat treating the porous filtration medium comprises: heating the porous filtration medium at a temperature of at least 70° C., at least 80° C., at least 90° C., at least 100° C., or at least 120° C.; heating the porous filtration medium at a temperature of up to 130° C., up to 140° C., or up to 150° C.; heating the porous filtration medium to a temperature of at least 70° C., at least 80° C., at least 90° C., at least 100° C., or at least 120° C.; heating the porous filtration medium to a temperature of up to 130° C., up to 140° C., or up to 150° C.; heating the porous filtration medium for at least 1 minute, at least 2 minutes, or at least 3 minutes; and/or heating the porous filtration medium for up to 3 minutes, up to 4 minutes, up to 5 minutes, or up to 10 minutes.

Aspect 11 is the article of any one of Aspects 3 to 10, wherein depositing the fluoropolymer-liquid mixture onto the porous filtration medium comprises immersing the porous filtration medium in the fluoropolymer-liquid mixture.

Aspect 12 is the article of any one of the preceding Aspects, wherein the fluoropolymer comprises poly(2,2,3,3,4,4,4-heptafluorobutyl methacrylate), and wherein the number average molecular weight (Mn) of the fluoropolymer is at least 3 kDa, at least 5 kDa, at least 10 kDa, at least 100 kDa, at least 150 kDa, at least 200 kDa, at least 250 kDa, at least 300 kDa, or at least 350 kDa.

Aspect 13 is the article of any one of the preceding Aspects, wherein the fluoropolymer comprises poly(2,2,3,3,4,4,4-heptafluorobutyl acrylate), and wherein the number average molecular weight (Mn) of the fluoropolymer is at least at least 3 kDa, at least 5 kDa, 10 kDa, at least 100 kDa, at least 150 kDa, at least 200 kDa, at least 250 kDa, at least 300 kDa, or at least 350 kDa.

Aspect 14 is the article of any one of the preceding Aspects, wherein the article further comprises a support layer.

Aspect 15 is the article of Aspect 14, wherein the support layer comprises a polymeric material.

Aspect 16 is the article of Aspect 15, wherein the polymeric material comprises polypropylene, polyethylene, polyester, or nylon, or a combination thereof.

Aspect 17 is the article of any one of the preceding Aspects, wherein the treated porous filtration medium is oleophobic on two major surfaces of the porous filtration medium. The treated porous filtration medium may have an oleophobicity of 1 or higher, 2 or higher, 3 or higher, 4 or higher, 5 or higher or 6 or higher on two major surfaces of the porous filtration medium. The treated porous filtration medium may have an oleophobicity of 7 or lower or 8 or lower on two major surfaces of the porous filtration medium. The treated porous filtration medium may have an oleophobicity of 3 to 8, from 4 to 8, or from 5 to 7, on two major surfaces of the porous filtration medium.

Aspect 18 is the article of any one of the preceding Aspects, wherein the article is oleophobic on two major surfaces of the article. The article may have an oleophobicity of 1 or higher, 2 or higher, 3 or higher, 4 or higher, 5 or higher or 6 or higher on two major surfaces of the porous filtration medium. The article may have an oleophobicity of 7 or lower or 8 or lower on two major surfaces of the porous filtration medium. The article may have an oleophobicity of 3 to 8, from 4 to 8, or from 5 to 7, on two major surfaces of the porous filtration medium.

Aspect 19 is a method of using the article of any one of the preceding Aspects.

Aspect 20 is the method of Aspect 19, the method comprising using the article as a biphasic separator.

### Exemplary Method Aspects

Aspect 1 is a method of making an article comprising a treated porous filtration medium, the method comprising: contacting a porous filtration medium with a mixture comprising a fluoropolymer and a liquid, depositing the fluoropolymer-liquid mixture onto the porous filtration medium to form the treated porous filtration medium, and removing the liquid, wherein the fluoropolymer comprises poly(2,2,3,3,4,4,4-heptafluorobutyl methacrylate) or poly(2,2,3,3,4,4,4-heptafluorobutyl acrylate).

Aspect 2 is the method of Aspect 1, wherein the liquid comprises an organic solvent.

Aspect 3 is the method of Aspect 2, wherein the organic solvent comprises methyl ethyl ketone (MEK) or a fluorosolvent.

Aspect 4 is the method of Aspect 3, wherein the fluorosolvent comprises a fluorinated ether.

Aspect 5 is the article of any one of the previous Aspects, wherein the fluoropolymer-liquid mixture comprises a fluoropolymer completely dissolved in the organic solvent.

Aspect 6 is the method of any one of the previous Aspects, wherein the fluoropolymer-liquid mixture comprises an emulsion.

Aspect 7 is the method of any one of the previous Aspects, wherein forming the treated porous filtration medium further comprises heat treating the treated porous filtration medium.

Aspect 8 is the method of Aspect 7, wherein heat treating the porous filtration medium comprises heating the porous filtration medium at a temperature of at least 70° C., at least 80° C., at least 90° C., at least 100° C., or at least 120° C.; heating the porous filtration medium at a temperature of up to 130° C., up to 140° C., or up to 150° C.; heating the porous filtration medium to a temperature of at least 70° C., at least 80° C., at least 90° C., at least 100° C., or at least 120° C.; heating the porous filtration medium to a temperature of up to 130° C., up to 140° C., or up to 150° C.; heating the porous filtration medium for at least 1 minute, at least 2 minutes, or at least 3 minutes; and/or heating the porous filtration medium for up to 3 minutes, up to 4 minutes, up to 5 minutes, or up to 10 minutes.

Aspect 9 is the method of any one of the previous Aspects, wherein contacting the porous filtration medium with the fluoropolymer-liquid mixture comprises immersing the porous filtration medium in the fluoropolymer-liquid mixture.

Aspect 10 is the method of any one of Aspects 1 to 9, wherein the fluoropolymer comprises poly(2,2,3,3,4,4,4-heptafluorobutyl methacrylate), and wherein the number average molecular weight (Mn) of the fluoropolymer is at least 3 kDa, at least 5 kDa, at least 10 kDa, at least 100 kDa, at least 150 kDa, at least 200 kDa, at least 250 kDa, at least 300 kDa, or at least 350 kDa.

Aspect 11 is the method of any one of Aspects 1 to 9, wherein the fluoropolymer comprises poly(2,2,3,3,4,4,4-heptafluorobutyl acrylate), and wherein the number average molecular weight (Mn) of the fluoropolymer is at least 3 kDa, at least 5 kDa, at least 10 kDa, at least 100 kDa, at least 150 kDa, at least 200 kDa, at least 250 kDa, at least 300 kDa, or at least 350 kDa.

Aspect 12 is the method of any one of the previous aspects, wherein the treated porous filtration medium is oleophobic on at least one major surface, as determined by AATCC test method 118, wherein the oleophobicity ratings are rounded to the nearest integer value. The treated porous filtration medium may have an oleophobicity of 1 or higher, 2 or higher, 3 or higher, 4 or higher, 5 or higher or 6 or higher on at least one major surface. The treated porous filtration medium may have an oleophobicity of 7 or lower or 8 or lower on at least one major surface. The treated porous filtration medium may have an oleophobicity of 3 to 8, from 4 to 8, or from 5 to 7, on at least one major surface.

Aspect 13 is the method of Aspect 12, wherein the treated porous filtration medium is oleophobic on two major surfaces of the porous filtration medium. The treated porous filtration medium may have an oleophobicity of 1 or higher, 2 or higher, 3 or higher, 4 or higher, 5 or higher or 6 or higher on two major surfaces of the porous filtration medium. The treated porous filtration medium may have an oleophobicity of 7 or lower or 8 or lower on two major surfaces of the porous filtration medium. The treated porous filtration medium may have an oleophobicity of 3 to 8, from 4 to 8, or from 5 to 7, on two major surfaces of the porous filtration medium.

Aspect 14 is the method of any one of the previous aspects, wherein the article is oleophobic on two major surfaces of the article. The article may have an oleophobicity of 1 or higher, 2 or higher, 3 or higher, 4 or higher, 5 or higher or 6 or higher on two major surfaces of the porous filtration medium. The article may have an oleophobicity of 7 or lower or 8 or lower on two major surfaces of the porous filtration medium. The article may have an oleophobicity of 3 to 8, from 4 to 8, or from 5 to 7, on two major surfaces of the porous filtration medium.

The present invention is illustrated by the following examples. It is to be understood that the particular examples, materials, amounts, and procedures are to be interpreted broadly in accordance with the scope and spirit of the invention as set forth herein.

### EXAMPLES

### Materials and Methods

All reagents, starting materials, and solvents used in the following examples were purchased from commercial suppliers (such as Sigma Aldrich, St. Louis, MO) and were used without further purification unless otherwise indicated.

### Number Average Molecular Weight (Mn) & Weight Average Molecular Weight (Mw)

Two PHENOGEL™ Mixed C columns (5 μm, 300 mm×7.8 mm; available from Phenomenex, Torrance, CA) were used in the loop. Hexafluoroisopropanol (HFIPA) was used as the solvent at a flow rate of 0.5 mL/min. Column temperature was 45° C. A refractive index detector was used as the sole detection method. A set of PMMA polymers (poly(methyl methacrylate) standard ReadyCal set Mp 800-2,200,000 Da, from Sigma Aldrich, St. Louis, MO) with the values of the molecular weight corresponding to that of the maximum of the chromatographic peak (Mp) ranging from 800 Da to 2,200 kDa were used to generate a calibration curve, which is shown in Table 1.

All number average molecular weight (Mn), weight average molecular weight (Mw), and degree of polymerization (n) values reported herein were obtained using this calibration set and GPC parameters. Degree of polymerization (n) was determined by dividing the Mn value by the monomer's molecular weight (MW).

TABLE 1

| Retention Time | | | | |
|---|---|---|---|---|
| (min) | Mp | Mw | Mn | Log Mp |
| 14.4 | 2200000 | 1890000 | 1650000 | 6.3 |
| 15.2 | 340000 | 335000 | 323000 | 5.5 |
| 15.8 | 608000 | 592000 | 561000 | 5.8 |
| 16.3 | 41400 | 40300 | 38100 | 4.6 |
| 16.9 | 88500 | 86700 | 83700 | 4.9 |
| 17.8 | 5050 | 4990 | 4690 | 3.7 |
| 18.7 | 9680 | 9590 | 9100 | 4.0 |
| 19.5 | 800 | 831 | 730 | 2.9 |

### Glass Transition Temperature (T_{g})

Glass transition temperatures (Tg) of polymers were obtained using a Q2000 DSC (available from TA Instruments, New Castle, DE). A typical DSC run procedure was as follows: Cycle 1: room temperature to 105° C. to 23° C. Cycle 2: 23° C. to 105° C. to -90° C. Cycle 3: -90° C. to 105° C. to -90° C. Cycle 4: -90° C. to 105° C. to 23° C. The scan rate was 10° C/min. The glass transition peak was calculated using the embedded software features on the second cycle.

### Fluoropolymers

### General Fluoropolymer Synthesis Method

A 20 mL scintillation vial was charged with the indicated amount of monomer, azobisisobutyronitrile (AIBN), and solvent, and a magnetic stir bar was added. The vial was securely closed and sparged with Argon for 5 minutes to remove air. The vial containing the reaction mixture was placed in a custom aluminum block affixed to a hot plate/magnetic stirrer controlled utilizing a feedback probe and preheated to 65° C. The polymerization reaction was allowed to proceed overnight (at least 12 hours) at 65° C. Kinetic analysis revealed the reactions were complete within 10 hours. The reaction mixture was cooled to room temperature and diluted with solvent to a desired w/v %. The concentration of the solution was validated by pipetting 1 mL of the solution into a pre-weighed petri dish. The solvent was evaporated and the petri dish was weighed again to obtain mass of polymer.

The resulting solution was used directly for coating of samples, as further described below.

poly(2,2,2-trifluoroethyl methacrylate) (“Polymer 1A” & “Polymer 1B”)

High Molecular Weight (MW) poly(2,2,2-trifluoroethyl methacrylate) (“Polymer 1A,” Mn=25.3 kDa, Mw=61.4 kDa, Mw/Mn=2.4) was purchased from Scientific Polymer Products (Ontario, New York). Low MW poly(2,2,2-trifluoroethyl methacrylate) (“Polymer 25 1B,” Mn=3.1 kDa, Mw=8.6 kDa, Mw/Mn=2.8) was purchased from Polymer Source (Montreal, Canada).

poly(2,2,3,3,3-pentafluoropropyl methacrylate) (“Polymer 2A” & “Polymer 2B”)

High MW poly(2,2,3,3,3-pentafluoropropyl methacrylate) (“Polymer 2A”) was produced as described in the General Fluoropolymer Synthesis Method using 5 g 2,2,3,3,3-pentafluoropropyl methacrylate, 0.024 g AIBN, and 3 mL NOVEC™ 7100 Engineered Fluid. The resulting polymer exhibited Mn=11.5 kDa, Mw=23.4 kDa, Mw/Mn=2.0.

Low Molecular Weight (MW) poly(2,2,3,3,3-pentafluoropropyl methacrylate) (“Polymer 2B”) was produced as described in the General Fluoropolymer Synthesis Method using 4 g 2,2,3,3,3-pentafluoropropyl methacrylate, 0.06 g AIBN, and 3 mL tetrahydrofuran (THF). Instead of being further diluted with solvent, as described in the General Fluoropolymer Synthesis Method, polymer was precipitated from THF using hexane and vacuum filtered out using cellulose filter paper in a Buechner funnel. The polymer was washed with copious amounts of hexane and air dried. Molecular weight data was not obtained for Polymer 2B.

poly(2,2,3,3,4,4,4-heptafluorobutyl methacrylate) (“Polymer 3A” & “Polymer 3B”)

High Molecular Weight (MW) poly(2,2,3,3,4,4,4-heptafluorobutyl methacrylate) (“Polymer 3A,” Mn=30.4 kDa, Mw=73.0 kDa, Mw/Mn=2.4) was purchased from Polymer Source (Montreal, Canada). Low M W poly(2,2,3,3,4,4,4-heptafluorobutyl methacrylate) (“Polymer 3B,” Mn=3.9 kDa, Mw=9.8 kDa, Mw/Mn=2.5) was purchased from Polymer Source (Montreal, Canada).

poly(1H,1H,2H,2H-nonafluorohexyl methacrylate) (“Polymer 4A” & “Polymer 4B”)

High Molecular Weight (MW) poly(1H,1H,2H,2H-nonafluorohexyl methacrylate) (“Polymer 4A”) polymer (Mn=52.5 kDa, Mw=135 kDa, Mw/Mn=2.6) was purchased from Polymer Source (Montreal, Canada). Low MW poly(1H,1H,2H,2H-nonafluorohexyl methacrylate) (“Polymer 4B,” Mn=7.1 kDa, Mw=15.6 kDa, Mw/Mn=2.2) was purchased from Polymer Source (Montreal, Canada).

poly(1H,1H,2H,2H-perfluorooctyl methacrylate) (“Polymer 5”)

High Molecular Weight (MW) poly(1H,1H,2H,2H-perfluorooctyl methacrylate) (“Polymer 5A”) was produced as described in the General Fluoropolymer Synthesis Method using 2 g 1H,1H,2H,2H-perfluorooctyl methacrylate, 0.07 g AIBN, and 2 mL NOVEC™ 7200

Engineered Fluid. The resulting polymer exhibited Mn=55.2 kDa, Mw=108.0 kDa, and Mw/Mn=2.0.

### Media

ePTFE media included Membrane A — Membrane D. Features of these media are shown in Table 2, below.

Air permeability in cubic feet per minute (CFM) was determined using an Air Permeability Tester Model FX3300 (Texttest AG, Schwerzenbach, Switzerland) at 0.5 inch of water of differential pressure. Air permeability may also be expressed in cm/min at 124.5 Pa differential pressure.

Thickness was determined using a Model 3W dial comparator (from B.C. Ames Incorporated, Framingham, MA) with base plate and moveable presser foot at 1.5 psi.

Pore Size was determined by capillary extrusion porometry with a Capillary Flow Porometer (from Porous Materials Inc., Ithaca, NY) using POROFIL™ (from Quantachrome Instruments, Boynton Beach, CA) as a wetting liquid and a dry up/wet up method.

TABLE 2

| | Perme- | Perme- | | | Aver- |
|---|---|---|---|---|---|
| | ability | ability | | | age |
| Mem- | (CFM @ | (cm/min @ | Thickness | Thickness | pore |
| brane | 0.5″ H₂O) | 124.5 Pa | (mils) | (μm) | size |
| A | 0.15 +/− | 4.6 +/− | 9.5 +/− | 241 +/− | 0.2 μm |
| | 0.08 | 2.4 | 1.0 | 25 | |
| B | 0.3-1.0 | 9.1-30.5 | 6.2 +/− | 157 +/− | not |
| | | | 2.3 | 58 | tested |
| C | ≥2.0 | ≥61 | 7.4-14.5 | 188-368 | 1.5 μm |
| D | 0.12-0.3 | 3.7-9.1 | 9.8-13.8 | 249-351 | 0.7 μm |

### Coating the Media

A coating solution including 1% — 6% (w/v) polymer in solvent (e.g., MEK or a fluorinated solvent) was poured into an aluminum petri dish to a sufficient depth so that media to be coated may be adequately submerged. The media was submerged at one end of the coating solution and pulled through the solution at a consistent angle until the entire media or substrate had been exposed to the solution. Once the media completely exited the solution at approximately the same angle as at entrance, the excess solvent on the surface and in the pores was allowed to drain for a few seconds. The coated media was then placed in a support form to prevent curling upon drying. After the coated media was visibly dry (typically about 10-30 seconds, depending on media grade), it was placed in an oven at 120° C. for 3 minutes.

### Testing Oleophobicity

To determine the oleophobicity rating on a scale of 1 to 8, testing for oleophobicity was performed according to AATCC TM118-2013e2 entitled “Oil Repellency: Hydrocarbon Resistance Test,” modified by rounding the oleophobicity ratings to the nearest integer value. Briefly, drops of various oils (described in Table 3) were placed on the coated media. Each oil drop was allowed to sit for one minute before the oleo rating was recorded. If a shadow appeared under the droplet, wetting by that oil was recorded; if no shadow appeared under a droplet, no wetting was recorded. Even the slightest appearance of a shadow constituted a wetting.

Resistance to wetting by KAYDOL® (available from Sonneborn, Inc. in Parsippany, NJ) indicates an oleophobicity rating of 1; resistance to wetting by a 65:35 mixture of KAYDOL:n-hexadecane indicates an oleophobicity rating of 2; resistance to wetting by n-hexadecane indicates an oleophobicity rating of 3; resistance to wetting by n-tetradecane indicates an oleophobicity rating of 4; resistance to wetting by n-dodecane indicates an oleophobicity rating of 5; resistance to wetting by n-decane oleophobicity rating of 6; resistance to wetting by n-octane oleophobicity rating of 7; resistance to wetting by n-heptane oleophobicity rating of 8.

TABLE 3
Oils used in the oleophobicity test.

| Oil | ST (mN/m) | Oleo Rating |
|---|---|---|
| Kaydol | 31.5 | 1 |
| 65:35 Kaydol:n-hexadecane | 29.6 | 2 |
| n-hexadecane | 27.3 | 3 |
| n-tetradecane | 26.4 | 4 |
| n-dodecane | 24.7 | 5 |
| n-decane | 23.5 | 6 |
| n-octane | 21.4 | 7 |
| n-heptane | 19.5 | 8 |

(ST = surface tension)

### Example 1

A coating solution of 5% (w/v) or 6% (w/v) of each polymer in solvent (as indicated in Table 4) was made, and successive concentrations (for example, 5%, 4%, 3%, 2%, and 1%) were obtained via dilutions of the original solution. The coating solution was used to coat four different types of media as described in the Methods section. Oleophobicity of each media grade at each polymer concentration was evaluated. Exemplary results for high Mn poly(2,2,2-trifluoroethyl methacrylate) (“Polymer 1A”) are shown in FIG. 1B. Exemplary results for high Mn poly(2,2,3,3,4,4,4-heptafluorobutyl methacrylate) (“Polymer 3A”) and low Mn poly(2,2,3,3,4,4,4-heptafluorobutyl methacrylate) (“Polymer 3B”) are shown in FIG. 1C.

TABLE 4

| Polymer | Solvent |
|---|---|
| Polymer 1A | MEK |
| Polymer 1B | MEK |
| Polymer 2A | NOVEC ™ 7100 |
| Polymer 2B | MEK |
| Polymer 3A | NOVEC ™ 7200 |
| Polymer 3B | NOVEC ™ 7200 |
| Polymer 4A | NOVEC ™ 7200 |
| Polymer 4B | NOVEC ™ 7200 |
| Polymer 5 | NOVEC ™ 7200 |

The best oleophobicity rating achieved for a coating solution between 2-4% (w/v) for each of the four media grades was determined for each fluorinated methacrylate and that oleophobicity rating is plotted against the number of fluorinated carbons in the fluorinated methacrylate, as shown in FIG. 1D-FIG. 1G. The weight average molecular weights (Mn) of the polymers plotted are shown in Table 5.

TABLE 5

| | Mn | Mw | Mw/Mn |
|---|---|---|---|
| Polymer 1A | 25300 | 61400 | 2.4 |
| Polymer 1B | 3110 | 8620 | 2.8 |
| Polymer 2A | 11500 | 23400 | 2.0 |
| Polymer 2B | (no data) | (no data) | (no data) |
| Polymer 3A | 30400 | 73000 | 2.4 |
| Polymer 3B | 3920 | 9750 | 2.5 |
| Polymer 4A | 52500 | 135000 | 2.6 |
| Polymer 4B | 7140 | 15600 | 2.2 |
| Polymer 5A | 55200 | 108000 | 2.0 |

As can be seen in FIG. 1D-FIG. 1G, oleophobicity of poly(2,2,3,3,4,4,4-heptafluorobutyl methacrylate) (for both high and low molecular weights, Polymer 3A & Polymer 3B, respectively), was higher than expected based on the trendline on each media tested.

### Example 2

High molecular weight poly(2,2,3,3,4,4,4-heptafluorobutyl methacrylate) (“Polymer 3A”) having different degrees of polymerization was produced as described in the General Fluoropolymer Synthesis Method using 5 g 2,2,3,3,4,4,4-heptafluorobutyl methacrylate, using varying amounts of AIBN (from 0.002 g to 0.025 g), and 4 mL Novec™ 7100 Engineered Fluid.

The polymers were coated on media using a 3% (w/v) solution, and oleophobicity was tested on Membranes A-D. Similar initial oleophobicity ratings were observed at Mn values ranging from 166 kDa to 389 kDa, indicating that higher molecular weight poly(2,2,3,3,4,4,4-heptafluorobutyl methacrylate) did not provide improved initial oleophobicity over lower molecular weight polymers.

### Example 3

Poly(2,2,3,3,4,4,4-heptafluorobutyl acrylate) (“Polymer 3Z”) was produced as described in the General Fluoropolymer Synthesis Method using 5 g 2,2,3,3,4,4,4-heptafluorobutyl acrylate, 0.036 g AIBN, and 4 mL NOVEC™ 7100 Engineered Fluid. The resulting polymer exhibited Mn=390 kDa, Mw=429 kDa, and Mw/Mn=1.10.

A coating solution of 3% (w/v) in NOVEC™ 7100 Engineered Fluid was made, and the coating solution was used to coat Membranes A-D as described in the Methods section. Oleophobicity of each media grade at each polymer concentration was evaluated and was found to be comparable to high Mn poly(2,2,3,3,4,4,4-heptafluorobutyl methacrylate) (“Polymer 3A”), prepared as described in Example 1. Results are shown in Table 6.

TABLE 6

| | Oleophobicity Rating | | | |
|---|---|---|---|---|
| | Membrane A | Membrane B | Membrane C | Membrane D |
| Polymer 3A | 6 | 6 | 6 | 7 |
| Polymer 3Z | 6 | 6 | 5 | 6 |

The complete disclosure of all patents, patent applications, and publications, and electronically available material cited herein are incorporated by reference. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

1. An article comprising:
a porous filtration medium; and
a fluoropolymer disposed on the porous filtration medium forming a treated porous filtration medium;
wherein the treated porous filtration medium has an oleophobicity of at least 1 on at least one major surface, as determined by AATCC test method 118, wherein oleophobicity ratings are rounded to nearest integer value, and
wherein the fluoropolymer comprises poly(2,2,3,3,4,4,4-heptafluorobutyl methacrylate) or poly(2,2,3,3,4,4,4-heptafluorobutyl acrylate).

2. The article of claim 1, wherein the porous filtration medium comprises expanded polytetrafluoroethylene (ePTFE), polyurethane, polypropylene, polyethylene, polyether sulfone, polyvinylidene fluoride, polycarbonate, polyolefin, polyamide, polyester, polysulfone, polyether, acrylic polymers, methacrylic polymers, polystyrene, a cellulosic polymer, or glass, or a combination thereof.

3. The article of claim 1, wherein the treated porous filtration medium is formed by a method comprising:
depositing a fluoropolymer-liquid mixture onto the porous filtration medium by contacting the porous filtration medium with a mixture comprising the fluoropolymer and a liquid; and
removing the liquid.

4. The article of claim 3, wherein the liquid comprises an organic solvent.

5. The article of claim 4, wherein the organic solvent comprises methyl ethyl ketone (MEK) or a fluorosolvent comprising fluorinated ether.

6. (canceled)

7. The article of claim 4, wherein the fluoropolymer-liquid mixture comprises a fluoropolymer completely dissolved in the organic solvent.

8. The article of claim 3, wherein the fluoropolymer-liquid mixture comprises an emulsion.

9. The article of 3, wherein forming the treated porous filtration medium further comprises heating the treated porous filtration medium to a temperature of at least 70° C. for at least 1 minute.

10. (canceled)

11. The article of 3, wherein depositing the fluoropolymer-liquid mixture onto the porous filtration medium comprises immersing the porous filtration medium in the fluoropolymer-liquid mixture.

12. The article of claim 1, wherein the fluoropolymer comprises poly(2,2,3,3,4,4,4-heptafluorobutyl methacrylate) or poly(2,2,3,3,4,4,4-heptafluorobutyl acrylate) or a combination thereof, and wherein the number average molecular weight (Mn) of the fluoropolymer is at least 3 kDa.

13. (canceled)

14. The article of claim 1, wherein the article further comprises a support layer comprising polymeric material.

15. (canceled)

16. The article of claim 1, wherein the polymeric material comprises polypropylene, polyethylene, polyester, or nylon, or a combination thereof

17. The article of any one of the preceding claimsclaim 1, wherein the treated porous filtration medium has an oleophobicity of 2 or higher on at least one major surface.

18. (canceled)

19. (canceled)

20. (canceled)

21. (canceled)

22. The article of claim 1, wherein the article is suitable for use as a biphasic separator.

23. A method of making an article comprising a treated porous filtration medium, the method comprising:
depositing a fluoropolymer-liquid mixture onto porous filtration medium by contacting the porous filtration medium with a mixture comprising a fluoropolymer and a liquid to form the treated porous filtration medium; and
removing the liquid,
wherein the fluoropolymer comprises poly(2,2,3,3,4,4,4-heptafluorobutyl methacrylate), poly(2,2,3,3,4,4,4-heptafluorobutyl acrylate), or a combination thereof.

24. The method of claim 23, wherein the liquid comprises an organic solvent.

25. The method of claim 24, wherein the organic solvent comprises methyl ethyl ketone (MEK) or a fluorosolvent comprising a fluorinated ether.

26. (canceled)

27. The article of claim 24, wherein the fluoropolymer-liquid mixture comprises a fluoropolymer completely dissolved in the organic solvent.

28. The method of claim 23, wherein the fluoropolymer-liquid mixture comprises an emulsion.

29. The method of claim 23, wherein forming the treated porous filtration medium further comprises heating the treated porous filtration medium to a temperature of at least 70° C. for at least 1 minute.

30. (canceled)

31. The method of claim 23, wherein contacting the porous filtration medium with the fluoropolymer-liquid mixture comprises immersing the porous filtration medium in the fluoropolymer-liquid mixture.

32. The method of claim 23, wherein the fluoropolymer comprises poly(2,2,3,3,4,4,4-heptafluorobutyl methacrylate), poly(2,2,3,3,4,4,4-heptafluorobutyl acrylate), or a combination thereof, and wherein the number average molecular weight (Mn) of the fluoropolymer is at least 3 kDa.

33. (canceled)

34. The method of claim 23, wherein the treated porous filtration medium has an oleophobicity of 1 or higher on at least one major surface, as determined by AATCC test method 118, wherein oleophobicity ratings are rounded to nearest integer value.

35. (canceled)

36. (canceled)

37. (canceled)
